(19) United States
(12) Patent Application Publication
(10) Pub. No.: US 2008/0104624 A1
(43) Pub. Date: May 1, 2008

(54) METHOD AND SYSTEM FOR SELECTION AND SCHEDULING OF CONTENT OUTLIERS

(75) Inventors: Nitya Narasimhan, Lake Zurich, IL (US); Rohit Chaudhri, Schaumburg, IL (US); Venugopal Vesudevan, Palatine, IL (US); Rodd B. Zurcher, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/555,517

(22) Filed: Nov. 1, 2006

(51) Int. Cl. H04N 7/173; H04N 7/16; H04H 60/33; H04H 9/00

(52) U.S. Cl. 725/13; 725/24

(57) ABSTRACT

A content recommendation system (100) to schedule a delivery of diverse content when a user is more receptive to the recommendation is provided. The system can include an outlier scheduling module (120) for scheduling an insertion of an outlier (224) in a recommended content based on a schedule model (125) and a trigger policy (127), an outlier selection module (140) for selecting the outlier from recommended content of an affinity model (145) based on a selection policy (147), and an outlier evaluation module (160) for monitoring a current user context and adjusting the selecting and the scheduling of the outlier in response to a user feedback of the outlier. The content recommendation system can expose the user to diverse content based on the user's current consumption pattern and current context.

### FIELD OF THE INVENTION

The present invention relates to content distribution, and more particularly, to mobile devices.

### BACKGROUND

The use of portable electronic devices, radios, and mobile communication devices has increased dramatically in recent years. Moreover, the demand for communication devices that share content with other devices or systems has increased. Communication devices can include multimedia management systems to select and distribute content in accordance with a user's preferences. For example, affinity-driven models for content selection are generally focused on making the user aware of content that is similar to a user's stated preferences or historical consumption patterns. Affinity driven models select content that is least likely to disrupt the user's listening experience based on prior information. For example, an affinity model can identify songs that are within the same music style, and present the songs to the user during the listening session.

In such regard, an affinity model is analogous to a recommender system that identifies suitable content for the user based on either content-specific analysis, or based on the voting patterns of users. Such systems generally operate by determining the correlation between two items (A and B), or between two users (X and Y). In a first case, the recommender system can recommend item B to a user who likes or wants item A based on a close correlation between A and B. In a second case, the system can recommend other items purchased by user Y to user X based on the similarity in the preferences or purchase patterns of X and Y.

Affinity-based content recommendation and selection systems focus on making users aware of content that is closest to their preferences based on historical consumption patterns. However, given unlimited content and limited knowledge of users, such systems often make recommendations based on correlation of users or items to predict content that the user may like. One issue in such systems is the lack of mechanisms to elicit user feedback and refine the selection of the affinity driven model. That is, it is difficult to elicit user ratings that require minimal user effort, and it is difficult to capture feedback on the selected items for improving the selection quality. The quality of the recommendation generally relies on explicit (specified by ratings) or implicit (observed from actions) user feedback in order to personalize the system for that specific user. This is a difficult task since users are not naturally inclined to provide ratings, especially when faced with large populations of content items.

Another issue in such systems is a lack of mechanisms to inject calculated randomness into the recommendation system for exposing users to alternative content of which they would be otherwise unaware, but that could potentially be of interest to them. Most recommender systems, such as those using affinity-based models, select items that are closest to a user's current preferences. As a result, the system may consistently propose similar content, thereby providing redundant content to the user and creating a repetitive or boring experience. Accordingly, a need exists for a content recommendation system can recommend unfamiliar new content to the user at the most appropriate time, and that can tune its recommendations based on observing user response to scheduled content.

### SUMMARY

Broadly stated, embodiments of the invention are directed to a system and method that selects and schedules content in a manner that exposes users to content at an appropriate time such that their listening experience is least degraded, making the user most receptive to that recommendation of content.

One embodiment is directed to a content recommendation system for introducting outlier content. An outlier is a recommendation of content that is outside a user's typical consumption experience. The content recommendation system includes an outlier scheduling module for scheduling an insertion of an outlier in a recommended content to provide content diversity and tune the affinity model, an outlier selection module coupled to the outlier scheduling module for selecting the outlier based on a selection policy, and an outlier evaluation module coupled to the outlier selection module for monitoring a current user context and adjusting the selecting and the scheduling of the next outlier in response to a user feedback on the current outlier. The outlier scheduling module provides a contextual trigger to initiate outlier selection based on a schedule model and a trigger policy. Examples of a trigger policy include random triggering, periodic triggering, context aware triggering, or resource aware triggering. The outlier selection module inserts the outlier in recommended content to expose a user to alternative content based on the current user context. The recommended content is provided by an affinity model. In one aspect, the outlier selection module selects outliers that are within a margin of recommendation. The outlier selection module selects a size of the margin to dynamically expose the user to content that is within a degree of tolerance of the user's current experience. The outlier selection module can change the size of the margin based on the user feedback for tuning the scheduling and selection of future outliers.

Further provided is a method for diverse content recommendation. Broadly stated, the method can include determining an appropriate time to make an outlier recommendation in view of a current user consumption of content, and triggering a selection and scheduling of the outlier in view of the appropriate time. In one arrangement, a user request or a system policy decision can be received for triggering the selection and scheduling of the outlier. In practice, an affinity model provides recommended content from which the outlier is selected. The method can include receiving recommended content from the affinity model, scheduling an insertion time for the outlier in the recommended content to expose the user to alternate content at the appropriate time, selecting an outlier in the recommended content in view of the current user consumption and insertion time, and monitoring a user acceptance of the outlier based on user feedback for adjusting the scheduling and selecting of the outlier. The step of scheduling an insertion time can include receiving a schedule and a trigger policy, and determining a contextual trigger to initiate outlier selection based on the schedule and trigger policy. The step of selecting an outlier can include evaluating a user affinity for the recommended content, and identifying an outlier based on the user affinity. The step of selecting an outlier can further include determining a margin size, evaluating a selection policy, and choosing outlier candidates in view of the margin size and the selection policy. In one aspect, a size of a margin for selecting content can be adjusted based on the user acceptance to tune the scheduling and selection of the outlier. The adjusting can dynamically expose the user to content that is within a degree of tolerance of the user's current experience based on the current user consumption.

Another embodiment of the invention is directed to a media player for dynamically adapting a user's media experience to diverse content. The media player can include an affinity model for producing recommended content, a scheduling model for triggering an insertion of an outlier in the recommended content, a media interface for playing the outlier and receiving user actions, and a content recommendation system receiving input from the affinity model. The outlier scheduling module can receive input from the scheduling module and generate a trigger context to schedule the outlier in view of a trigger policy. The outlier selection module can be coupled to the outlier scheduling module to receive the recommended content from the affinity driven model and determine an appropriate time to make an outlier recommendation in view of a selection policy and the trigger context. The outlier evaluation module can be coupled to the outlier selection module to provide feedback to the affinity model for adjusting the selecting and the scheduling of the outlier in response to the user action provided by the media interface.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a content recommendation in accordance with the embodiments of the invention;

FIG. 2 is a method for distributing diverse content in accordance with the embodiments of the invention;

FIG. 3 is a media interface for presenting content in accordance with the embodiments of the invention;

FIG. 4 is a method for outlier selection of diverse content in accordance with the embodiments of the invention;

FIG. 5 is a method for content recommendation in accordance with the embodiments of the invention;

FIG. 6 is an affinity vector of recommended content in accordance with the embodiments of the invention;

FIG. 7 is the affinity vector of FIG. 6 showing an insertion of an outlier in accordance with the embodiments of the invention;

FIG. 8 is an affinity vector with an increased margin in accordance with the embodiments of the invention;

FIG. 9 is an affinity vector with a decreased margin in accordance with the embodiments of the invention;

FIG. 10 is a first example of a contextual trigger in accordance with the embodiments of the invention;

FIG. 11 is a second example of a contextual trigger in accordance with the embodiments of the invention;

FIG. 12 is a cache and carry system in accordance with the embodiments of the invention; and

FIG. 13 is a cache and carry system for diverse content recommendation in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The term “outlier” can be defined as recommended content that is outside a normal set of content recommendations provided by an affinity-driven model. The term “user affinity” can be defined as a user's preference to content. The term “current user context” can be defined as the content that the user currently has preference towards during a delivery of recommended content and the context (e.g., resource availability, state) of the device on which the content is consumed. The term “content diversity” can be defined as content that is outside a user's current consumption patterns and usual preferences. The term “user feedback” can be defined as a user's response to an outlier. The term “contextual trigger” can be defined as an action to schedule an outlier during a delivery of recommended content. The term “recommended content” can be defined as an ordered list of content items based on user affinity. The term “trigger” can be defined as causing a scheduling action. The term “trigger policy” can be defined as an action that causes an outlier to be scheduled in view of a policy. The term “margin” can be defined as a range of a user's preference for content. The term “size of margin” can be defined as a degree of tolerance to a user's current preference. The term “tuning” can be defined as updating a system to perform selection and scheduling in accordance with a current user context. The term “current user consumption” can be defined as the current consumption of content by a user. The term “user acceptance” can be defined as a user's preference to content. The term “selection policy” can be defined as a trigger in response to a user request of a system-driven policy. The term “appropriate time” can be defined as a time a user is receptive to the diverse content. The term “insertion time” can be defined as the time at which the outlier is to be inserted into a playlist such that the outlier is then played to the user at the appropriate time.

Broadly stated, embodiments of the invention are directed to a content recommendation system that schedules and selects outliers at an appropriate time in a dynamic content consumption environment. In particular, the user's current preferences for content are taken into consideration in determining the appropriate time to introduce diverse content. Outliers are introduced for providing diverse content in accordance with the user's current content consumption patterns. The content recommendation system can also monitor a user's acceptance of the diverse content and tune the selection and scheduling in response to the user's acceptance. The content recommendation system can schedule and select an outlier based on the user's current consumption pattern and current context when the user is more receptive to new content. Notably, diverse content can be recommended at appropriate times so the user is introduced to content a time when the user is more receptive to the diverse content.

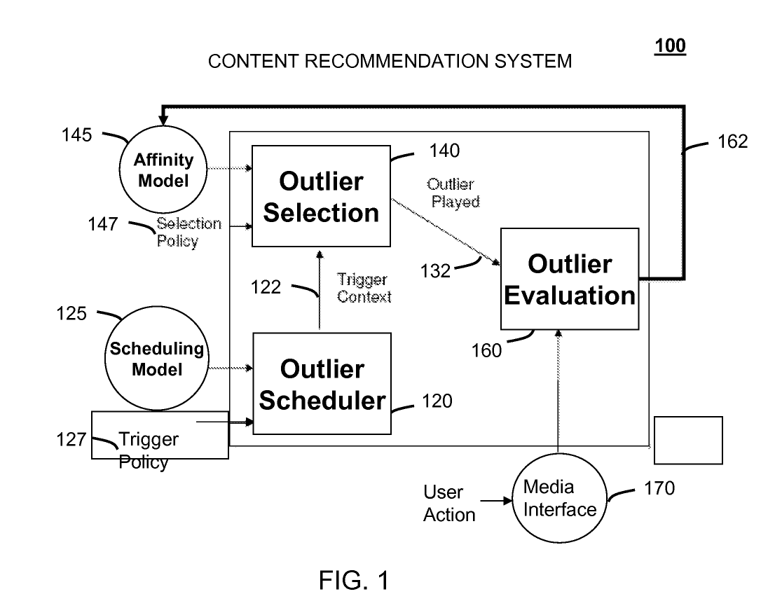

Referring to FIG. 1, a content recommendation system 100 is shown. The content recommendation system 100 can schedule and select content to be presented to a user for introducing the user to diverse content at an appropriate time. In particular, content outside a normal recommendation (e.g. diverse content) can be introduced based on a current user context. As an example, the content recommendation system 100 can be included within a mobile communication device, a computer, a server, a cell phone, a digital assistant, a portable music player or any other suitable communication device. The content recommendation system 100 can be implemented in hardware and/or software in embodiments such as a microprocessor or a digital signal processor including memory storage, but is not herein limited to such.

It should be noted that the content recommendation system 100 leverages an affinity model 145 and a media interface 170 during operation. The affinity model 145 provides recommended content from which the content recommendation system 100 selects and schedules outliers. The media interface 170 allows the content recommendation system 100 to receive user feedback and tune scheduling and selection of outliers. Broadly stated, the content recommendation system 100 identifies outliers in a recommended content and schedules the outliers based on a current user context. The content recommendation system 100 can include an outlier scheduling module 120, an outlier selection module 140, and an outlier evaluation module 160. It should be noted that the outlier selection module 140 receives the recommended content from the affinity model 145. The outlier selection module 140 selects and plays an outlier selection 132 in view of a selection policy 147 and a contextual trigger 122. It should also be noted that the outlier scheduling module 120 provides the contextual trigger 122 to initiate the outlier selection based on a schedule model 125 and a trigger policy 127. The outlier scheduling module 120 can trigger a selection and scheduling of an outlier in the recommended content based on the current user context.

Briefly, the affinity driven model 145 provides recommended content from which the outlier selection module 140 selects the outlier. Upon receiving the contextual trigger 122, the outlier selection module 140 then inserts the outlier to a new location in the recommended content to expose the user to alternative content. The outlier selection module 130 can exploit different selection policies to select an appropriate outlier for the current user context. In particular, the content recommendation system 100 can assess a current user context and current user consumption for selecting and scheduling outliers in the recommended content. That is, the content recommendation system 100 can expose the user to diverse content at an appropriate time when the user is more receptive to diverse content.

Referring to FIG. 1, the outlier evaluation module 160 can elicit user feedback 162 to reinforce or invalidate the selection and scheduling of an outlier from recommended content of an affinity model 145. That is, the content recommendation system 100 can tune the subsequent outlier scheduling and selection based on a user response to an outlier. The user response may be a favorable or negative acceptance of the outlier. Notably, the outlier evaluation module 160 provides for intelligent selection of outliers, and allows the outlier selection module 140 to self-correct based on dynamic user response behavior without requiring manual inputs. The combination of selection, triggering, and feedback with a policy that enables customization of their behaviors to meet specific contexts or system requirements is a novel aspect of the embodiments of the invention.

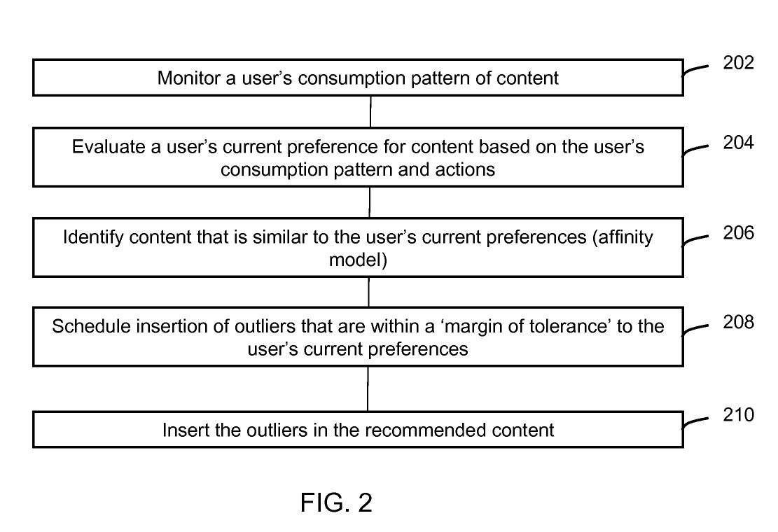

In practice, as shown in FIG. 2, the content recommendation system 100 can monitor a user's consumption of content (Step 202), evaluate a user's current preference for content based on the user's consumption pattern (Step 204), identify content that is similar to the user's current preferences (Step 206), schedule a delivery of outliers that are within a margin of tolerance to the user's current preferences (Step 208), and insert the outliers in the recommended content (Step 210). As shown in FIG. 1, the outlier evaluation module 160 is operatively coupled to the media interface 170 and the outlier selection module 140. The media interface 170 provides a mechanism for distributing recommended content and evaluating user acceptance of the recommended content.

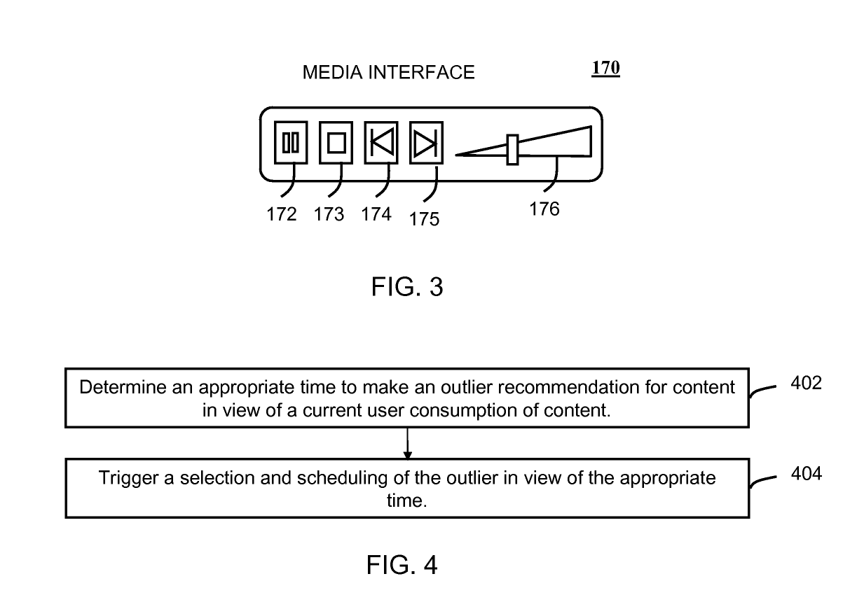

Referring to FIG. 3, the media interface 170 is shown. As an example, the media interface 170 can be a graphical user interface (GUI) of a mobile device providing access to multiple audio or video features. The media interface 170 can include one or more input buttons for monitoring a user's consumption of media. For example, the media interface 170 can include a pause button 172, a stop button 173, a back button 174, a forward button 175, and a volume 175 for audio content. The buttons 172-176 may serve similar purpose for indexing through videos or text messages presented on a screen (not shown).

The outlier evaluation module 160 can evaluate a user's response to an outlier via the media interface. The media interface 170 can send user actions to the outlier evaluation module 160 which can process the user actions. For example, the outlier may be a music song which is inserted into a stream of music data. The outlier evaluation module 160 can determine whether a user skips over an outlier by monitoring the forward button 175, or whether the user replays an outlier by monitoring the back button 176. Notably, the content recommendation system 100 includes the media interface 170 to monitor a current user consumption of content and evaluate a user's preference for content at an appropriate time. With respect to FIG. 4, the content recommendation system 100 can determine an appropriate time to make an outlier recommendation for content in view of a current user consumption of content (step 402), and trigger a selection and scheduling of the outlier in view of the appropriate time (step 404).

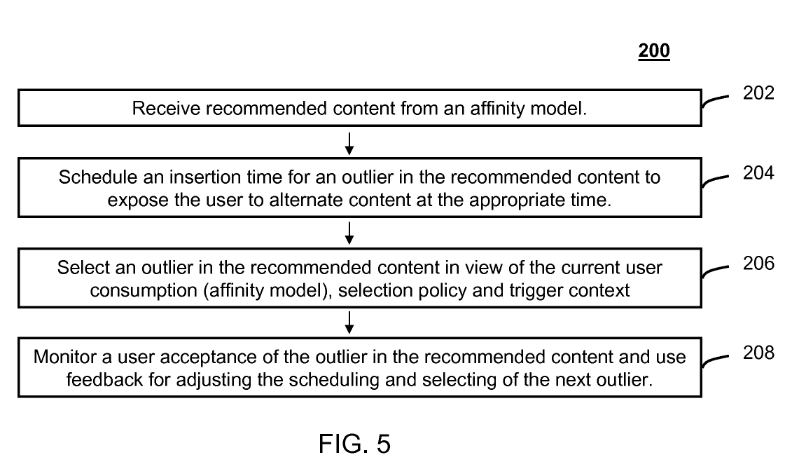

Referring to FIG. 5, a method 200 for intentional selection and scheduling of content outliers is shown. The method 200 can be practiced with more or less than the number of steps shown. The method 200 is also not limited to the order in which the steps are shown. When describing the method 200, reference will be made to FIG. 1 and FIGS. 6-11 although it must be noted that the method 200 can be practiced in any other suitable system or device.

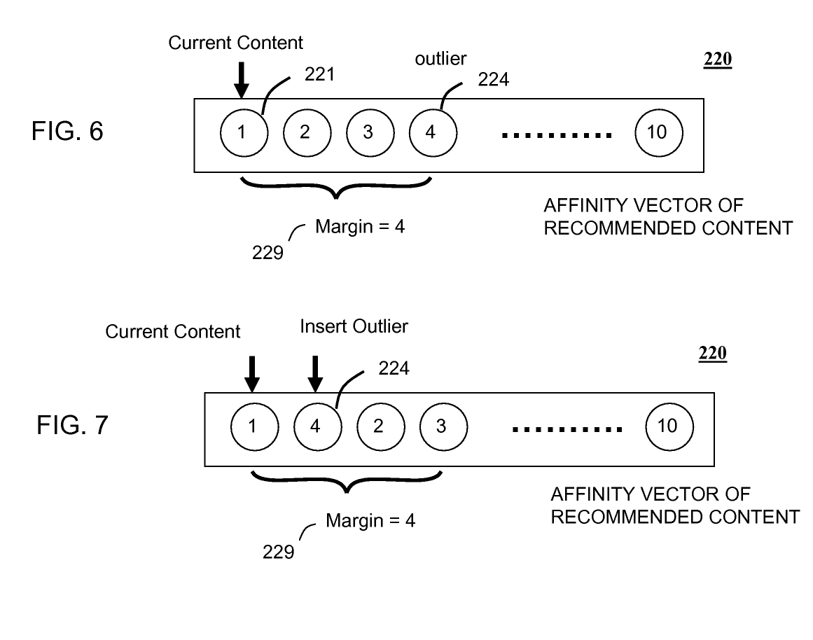

At step 202, recommended content can be received from an affinity-model. An affinity model can provide recommended content based on a user's preferences and current consumption patterns. It should be noted, however, that the affinity model 145 alone does not time the delivery of recommended content based. That is the affinity model does not determine an appropriate time. As shown in FIG. 1, the content recommendation system 100 influences the scheduling of the recommended content provided by the affinity model 145 to make diverse content recommendations based on current user context. That is, the content recommendation system 100 identifes an appropriate time to make a recommendation for diverse content. The affinity model 145 merely provides an affinity vector of recommended content. Referring to FIG. 6, an affinity vector 220 of recommended content is shown. The affinity vector 220 can include content items 221. A content item 221 can be a song, news cast, blog, message, or any other form of media and is not limited to these. The content recommendation system 100 (See FIG. 1) identifies a user's current preference for content and then schedules and selects content items in the affinity vector 220 in accordance with the current user context. For example, the content recommendation system 100 searches the affinity vector 220 for diverse content based on the current user context, and re-organizes the scheduling of content items in the affinity vector 200. For instance, the outlier 224 of FIG. 6 can be selected in the affinity vector 220 and inserted closer to the current content as shown in FIG. 7 based on current user context.

Returning back to FIG. 5, at step 204, an insertion time for an outlier can be scheduled in the recommended content to expose the user to diverse content at the appropriate time. Referring back to FIG. 1, the outlier scheduling module 120 receives a list of currently scheduled content from the schedule model 125 and a trigger policy 127 for triggering the selection of the outlier for scheduling next on the affinity-driven channel. The outlier scheduling module 120 can schedule an insertion of an outlier 224 in a recommended content to provide content diversity. The outlier scheduling module 120 provides a contextual trigger 122 to initiate outlier selection based on the schedule model 125 and the trigger policy 127. The outlier scheduling module 120 takes a current schedule from the schedule model 125 and the trigger policy 127 as inputs, and provides a contextual trigger 122 to initiate outlier selection. The contextual trigger 127 identifies a purpose of the outlier such as a user request or a system-driven policy decision. The contextual trigger acts as a guard to the outlier selection module 140, allowing user or policy-driven triggers to initiate the outlier selection. Thus, outlier selection can be triggered in response to a user request (“Surprise Me”) or in response to a system-driven policy decision. Examples of a system-driven policy decision can include—random triggering (coin toss), periodic triggering (every x songs), context aware triggering (break repetitive cycles) or resource-aware triggering (to mask latency). For example, an outlier can be scheduled if it is “readily-available” or cached-locally in order to cover a latency associated with acquiring the default-scheduled but currently-unavailable selection. Accordingly, the contextual trigger 122 can be a random triggering, periodic triggering, context aware triggering, or resource aware triggering. In general, the cost of outliers must be low for mobile content consumption.

For example, referring to FIG. 7, an insertion time for the outlier 224 can be selected in view of the current content 221. As an example, the insertion time may be just after the current content 221 or within a margin 229 of the current content 221. Briefly, the outlier is inserted into the scheduled content list at the instant that the outlier trigger occurs. The margin refers to the “distance” of an outlier (from the current song) in the recommendation list that is created by the affinity model in response to the user's listening habits. In the case of recommending music content, the outlier 224 can be a particular song that is outside a set of normal song recommendations, but within a margin 229 of selection. The margin 229 is a degree of tolerance of the user's preferences. For example, a margin of 4 indicates that the next 4 content items can be selected from in the affinity vector 220 for scheduling.

Returning back to FIG. 5, at step 206, an outlier can be selected in the recommended content in view of the current user consumption and insertion time. Recall in FIG. 1 that the outlier selection module 140 controls an actual selection of the outlier candidate based on the selection policy 147. The selection policy 147 can identify how content items 221 (See FIG. 6) are selected within the recommended content. The outlier selection module 140 focuses on selecting content that is available for scheduling, and that is marginally-outside of the user's current experience or preferences. The outlier selection module 140 in combination with the outlier scheduling module 120 and the outlier evaluation module 160 can adjust a size of the margin to dynamically expose the user to diverse content that is within a degree of tolerance of the user's current experience or preference. The diverse content is potentially outside the scope of what the user would have anticipated from the recommendation. In such regard, the recommendation of diverse content can “surprise” the user, or in another regard, prevent a repetitive or boring content consumption experience.

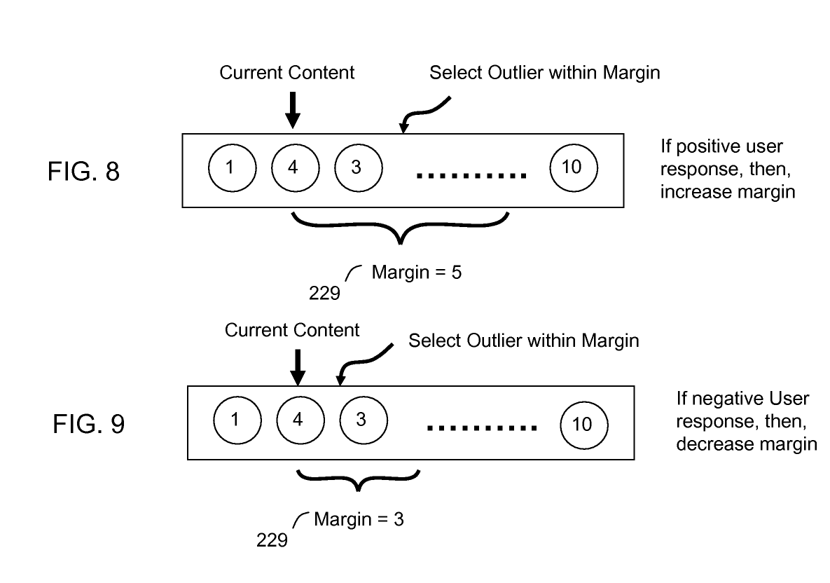

For example, referring to FIG. 6, a margin 229 of 4 content items is shown. In this case, an outlier can be selected from the next 4 content items in the affinity vector 220 with respect to the current content item. Referring to FIG. 8, the margin 229 can be increased if a user acceptance to the outlier is favorably received. Accordingly, more diverse content items can be selected from the affinity vector 220 for providing the next outlier, since the user has indicated a higher tolerance for ‘perturbation’ from the normally-scheduled content. Similarly, the margin 229 can be decreased if the user acceptance to the outlier is not favorably received as shown in FIG. 9. Accordingly, less diverse content (i.e., less perturbation from normal) can be selected from in the affinity vector 220 for limiting diverse content since the margin is smaller based on the user acceptance.

Returning back to FIG. 5, at step 208, a user acceptance of the outlier in the recommended content can be monitored based on user feedback for adjusting the scheduling and selecting of the outlier. A user acceptance is the user's feedback to the outlier. Referring to FIG. 1, the outlier evaluation module 160 assimilates the user's actions to the outlier and, in conjunction with the contextual trigger 122 and selection policy 147 in view of the current user context and consumption—can tune or reinforce the affinity model 145 used for making the recommendations. Recall, the outlier evaluation module 160 (See FIG. 1) assumes the existence of the media-player interface 170 for soliciting user acceptance. The media-player interface 170 enables user actions to be either inferred through user actions on that interface, or solicited through a voting interface. For example, inferred user actions can be based on implicit ratings, whereas solicited ratings can be based on explicit ratings. Based on user actions, the size of the margin can be adjusted to define a “window of opportunity” for item selection. Trigger context can also be a factor in deciding the outlier.

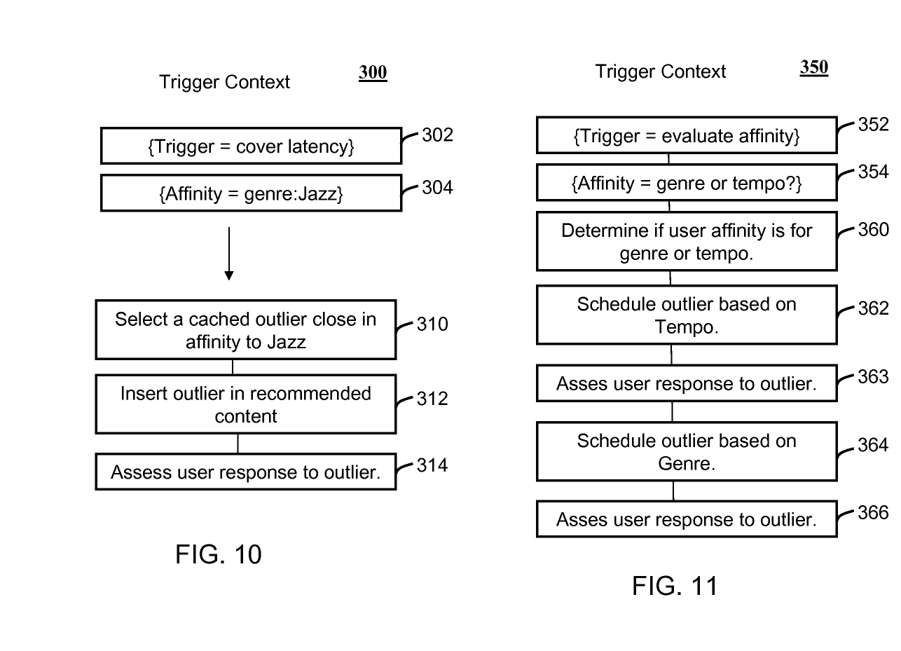

For example, referring to FIG. 10, a first trigger context for content delivery of music is shown as an example. The trigger context 300 includes a trigger reference 302 and an affinity reference 304. The trigger context 300 may be implemented as an XML script or any other object oriented programming code for providing associations. Trigger reference 302 for the provided trigger context 300 example identifies a trigger for covering a latency. For example, the content recommendation system 100 may encounter a delay in receiving content items. Accordingly, to prevent the user from receiving delayed media, the content recommendation system 100 may set a trigger to insert content when a latency in content is encountered.

The affinity reference 304 identifies the user's preference to content. In the example of trigger context 300, the user has a preference for a Jazz genre of music. Given trigger reference 302 {trigger=cover latency} and affinity reference 304 {affinity=genre:jazz}, the outlier selection module 140 looks for a cached outlier 224 in the affinity vector (See FIG. 6) that is relatively close in affinity to jazz but is potentially different from things user has listened to recently. This ensures the user continues to listen to the recommended content and does not look for the yet-to-be-obtained content to prevent boredom or repetitive experiences. In response to the trigger reference 302 and the affinity reference 304, the outlier selection module 140 selects an outlier that is close in affinity to Jazz (step 310) and inserts the outlier in the recommended content (step 312). The outlier evaluation module 160 can assess the user response to the outlier (step 314) and adjust the scheduling and selection of next outliers.

Referring to FIG. 11, a second trigger context 350 for content delivery of music is shown. Trigger reference 352 identifies a trigger for evaluating an affinity. That is, the user's preference for music is considered for selecting the outlier. Affinity reference 354 describes whether the preference is for the genre of music or the tempo of music. Given trigger reference 352 {trigger=evaluate affinity} and affinity reference 354 {affinity=genre or tempo?}, the outlier selection module 140 looks for an outlier 224 in the affinity vector (See FIG. 6) that can validate or tune the affinity by selecting an outlier 224 that is perceptibly more towards one affinity than another, and exploiting the user's action to validate the choice. Thus, if the current song fits into genre:jazz and tempo:slow—then, the content recommendation system 100 determines if user affinity is for the genre or the tempo (step 360). To do this, the outlier selection module 140 selects a fast jazz song and the outlier scheduling module 110 schedules the fast jazz song (step 362). The outlier evaluation module 160 determines if the user responds positively, and if so reinforces the affinity for the genre (step 363). That is, if the user accepts fast and slow jazz, the user's preference is for the jazz genre and not the tempo of the jazz. If the user responds negatively, the outlier selection module 140 can select a slow blues song to determine if the preference is for genre (step 364). Notably, a slow blues song and a slow jazz song are considered to have similar tempo but different genre. The outlier evaluation module 160 can trigger tuning and revalidation based on the slow blues song (step 366). The content recommendation system 110 can evaluate a user's acceptance to outliers based on margin size and trigger context. That is, the outlier selection module 140 chooses a candidate based on a specified policy or identified need. Policies can include least-perturbation from normal, most-perturbation from normal, least-recently-heard, and not currently owned. The outlier selection module 140 can select a song that is of a different genre or tempo but that is within the user's preference based on the current user context and the selection policy.

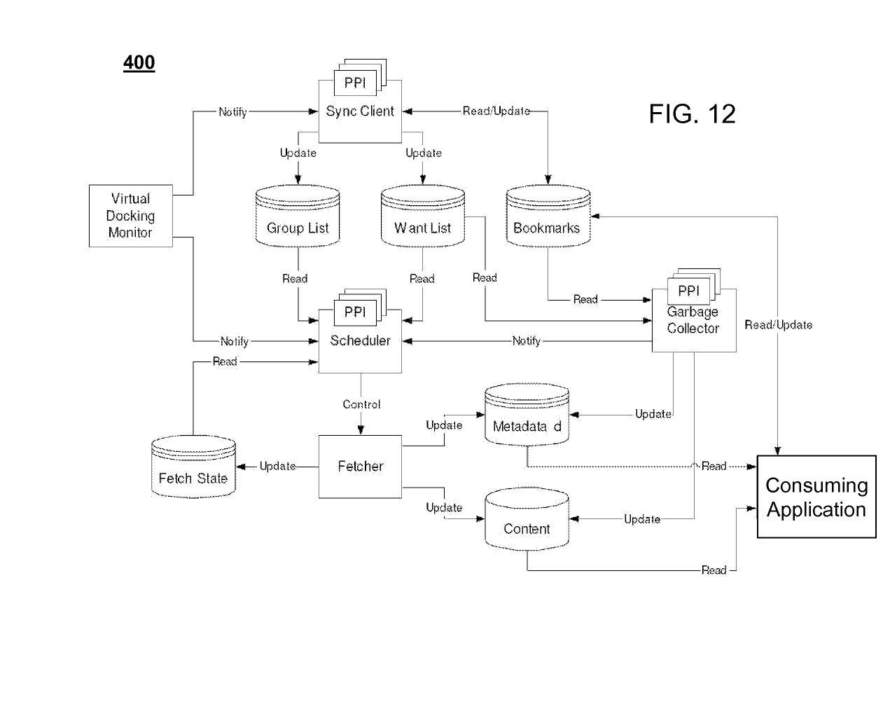

The content recommendation system 100 of FIG. 1 can support disconnected and/or asynchronous operation. As an example, content can be scheduled for delivery in a cache and carry system though is not herein limited to such. Referring to FIG. 12, a cache and carry system 400 is shown. The cache and carry system 400 is a content delivery system where scheduling of content can be influenced through an ‘affinity-driven’ channel 145 (See FIG. 1). Briefly, the cache and carry system 400 can be included in a mobile device such as a mobile phone or a portable music listening device but is not limited to such. The cache and carry system 400 can include a consuming application 160 having, as example, the media interface 170 of FIG. 3. The cache and carry system 400 can manage a delivery of content based on user feedback from the media interface 170. In particular, the cache and carry system 400 can identify a time to have a media delivered, assess delivery capabilities for distributing the media, and synchronize a delivery of the media in view of the delivery capabilities for having the media delivered on time. The step of synchronizing can include exchanging a first media for a second media to increase a storage capacity on a memory limited device. This can include identifying references to the first media and second during a first phase, and exchanging the first media and the second media during a second phase. A distribution time can be estimated in view of the delivery capabilities for the media, and a synchronization can be performed in view of the distribution time for fulfilling a distribution of the media on time.

Notably, the cache and carry system 400 can perform dynamic memory management for introducing diverse content in accordance with the embodiments of the invention. For example, during the insertion of an outlier into recommended content, media can be managed for properly allowing the insertion of the outlier. For example, if the outlier is not immediately available, the cache and carry system 400 can cover a latency in delivering the outlier. As an example, the cache and carry system 400 can search for media to exchange among a plurality of physical spaces containing media that is frequently accessed, and identify at least one physical space having a capacity to perform the exchanging in view of the time.

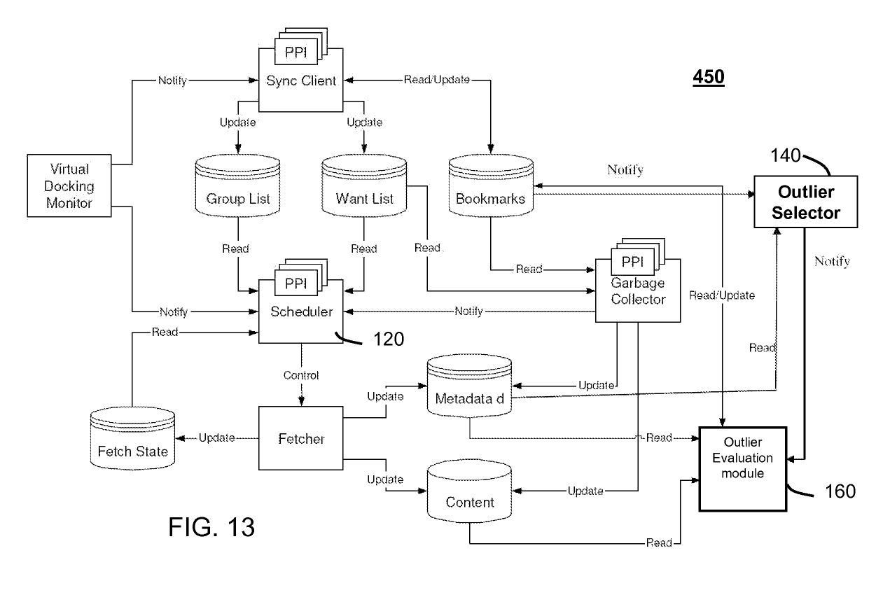

Referring to FIG. 13, a cache and carry content recommendation system 450 is shown. In particular, the content recommendation system 100 is integrated within the cache and carry system 400 of FIG. 12 to introduce diverse content at an appropriate time when the user is most receptive to the diverse content. The outlier selection module 140 can be coupled to one or more databases of the cache and carry system 400 of FIG. 12 for selecting content. The outlier selection module 140 can be an inherent component of the cache and carry system that determines when content is to be scheduled. The outlier evaluation module 160 can be included in the consuming application to acquire and monitor user feedback to outliers. The cache and carry system 450 of FIG. 13 can support connected and/or synchronized operation, such as streaming media for online radio stations, LaunchCasts, Blogs, or messaging services.

One advantage of the cache and carry content recommendation system 450 is a self-tuning approach that can use a combination of outliers and implicit user feedback to adapt dynamically to the user's media experience needs. This reduces user effort required in customizing schedules or making recommendations. The content recommendation system observes dynamic consumption and uses outliers to self-adjust a hypothesis of the user's preference for content. Consequently, users receive a diverse listening experience using a policy-driven approach for auto-scheduling outliers. This reduces a monotony of a redundant listening experience. Moreover, content recommendation system can mask inefficiencies or delays in the delivery of content without adversely affecting the user experience. That is, the user is presented with outliers as a ‘surprise enhancement’ and is made less aware of potential breaks in his listening schedule.

In the foregoing, a brief description of the operation of the cache and carry content recommendation system 450 is provided. As an example, the cache and carry content recommendation system 450 can be implemented in a mobile device such as a cell phone. It should be noted that the cache and carry content recommendation system 450 assumes a multi-channel content delivery system for influencing the scheduling of content on an affinity-driven channel, and assumes a media player interface such as FIG. 3 for allowing user actions (e.g., skip, pause, rewind, repeat, forward, stop) to infer user votes on content.

Referring to FIG. 13, the outlier scheduling module 120 can determine the affinity vector for a current content item. For example, referring to FIG. 6, the scheduler can select an outlier 424 which is marginally offset from the current content item 221, in lieu of scheduling the current content item 221. The outlier scheduling module 120 can use the current context as criteria for determining the marginal offset. The marginal offset is also the margin size 229 (See FIG. 6). For example, if the affinity 304 (See FIG. 10) is by genre and the user is listening to jazz music, then a marginal offset 229 might be a collaboration between a jazz artist and a blues singer—potentially exposing the listener (in due course) to other pure-blues music and artists. Referring to FIG. 13, the outlier selector 140 can select an outlier from the recommended content that is within the margin 229. The outlier evaluation module 160 of the consuming application can observe the user feedback to the scheduling of the outlier, and employ the user feedback to tune the affinity model, and also tune the size of the margin.

For example, referring back to FIG. 6, the affinity vector 220 consisting of items {1, 2, 3, 4 . . . 10} with a margin 229 value of 4 is provided. It should be noted that the cache and carry system 400 of FIG. 12 will present the content items in the affinity vector 220 to the user in the order provided. In contrast, it should be noted that the cache and carry system 450 of FIG. 13 reorders the content items based on the current user context. That is, the outlier mechanism of the outlier scheduling module module 120, outlier selection module 140, and outlier evaluation module 160 of FIG. 1 take into consideration the users current preferences based on current user consumption when introducing diverse content. Accordingly, outliers are inserted in the recommended content when the user is most receptive to diverse content based on the user's current consumption. For example, as shown in FIG. 6, the cache and carry system 450 can instead schedule an item within “4” slots of this item, corresponding to the margin 229. Furthermore, the cache and carry system 450 can select the most appropriate item within the margin 229 based on several criteria including diversity (e.g., select the item that is of a different genre from the current item), last-played (e.g., select the item that was least-recently played of the 4) or ownership status (e.g., select an item that the user does not own in preference to content in his/her possession).

The user can now respond to the outlier in a positive manner, such as listening to the content item, or a negative manner, such as skipping the song immediately. Recall, the media interface 170 (See FIG. 3) of the outlier evaluation module 160 can receive and process user feedback, such as the pressing of a play button 173 or a skip button 175 to provide voting analysis. The outlier evaluation module 160 can use the inherent voting analysis of the media interface 170 to increase or decrease the size of the margin 229. In one arrangement, the outlier evaluation module 160 can completely disable the scheduling, selection, and insertion of an outlier. Such a case may be warranted if a margin analysis reveals non-convergent results or if the margin is effectively set to zero.

Continuing with the above example of FIG. 6, the cache and carry system 450 may elect to schedule song 2. If the user responds positively, the cache and carry system 450 may then schedule song 6 the next time (4 away from 2). If the user now responds negatively, the cache and carry system 450 may tune margin size 229 down to 3 and recommend 4 instead (2+2). Alternatively, if the user continues to respond positively, the cache and carry system 450 may increase the margin to 5 the next time; effectively giving the outlier-selection mechanism more options to select from.

In summary, the content recommendation system 100 of FIG. 1, as integrated within a cache and carry system of FIG. 12, provides a tunable mechanism for recommending content at a time when a user is more receptive to diverse content. The tunable mechanism is realized through an outlier scheduling module, an outlier selector, and an outlier evaluation module. The content recommendation system 100 selects outliers that are appropriate for the current user context and schedules them in a dynamic content consumption environment.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A content recommendation system, comprising:
an outlier scheduling module for scheduling an insertion of an outlier in a recommended content to provide content diversity at an appropriate time;
an outlier selection module coupled to the outlier scheduling module for selecting the outlier based on a selection policy; and
an outlier evaluation module coupled to the outlier selection module for monitoring a current user context and adjusting the selecting and the scheduling of the outlier in response to a user feedback of the outlier,
wherein an affinity model produces recommended content and the outlier selection module inserts the outlier in the recommended content to expose a user to alternative content based on the current user context.

2. The content recommendation system of claim 1, wherein the outlier scheduling module provides a contextual trigger to initiate outlier selection based on a schedule model and a trigger policy.

3. The content recommendation system of claim 2, wherein the contextual trigger is at least one of a random triggering, periodic triggering, context aware triggering, or resource aware triggering.

4. The content recommendation system of claim 1, wherein the outlier selection module selects outliers that are within a margin of tolerance, for recommendation.

5. The content recommendation system of claim 4, wherein the outlier selection module selects a size of the margin to dynamically expose the user to content that is within a degree of tolerance of the user's current experience.

6. The content recommendation system of claim 5, wherein the outlier selection module changes the size of the margin based on the user feedback for tuning the scheduling and selection of outliers.

7. A method for diverse content recommendation, comprising:
determining an appropriate time to make an outlier recommendation in view of a current user consumption of content; and
triggering a selection and scheduling of an outlier in view of the appropriate time,
wherein the outlier is recommended at the appropriate times such that a user is introduced to diverse content a time that the user is more receptive to the diverse content.

8. The method of claim 7, wherein determining an appropriate time further comprises:
receiving a user request or a system policy decision for triggering the selection and scheduling of the outlier.

9. The method of claim 7, wherein triggering a selection and scheduling further comprises:
receiving recommended content from an affinity-driven channel;
scheduling an insertion time for an outlier in the recommended content to expose the user to alternate content at the appropriate time;
selecting an outlier in the recommended content in view of the current user consumption and according to a system-driven selection policy; and
monitoring a user acceptance of the outlier in the recommended content based on user feedback for adjusting the scheduling and selecting of the outlier.

10. The method of claim 9, wherein the step of scheduling an insertion time further comprises:
receiving a schedule and a trigger policy; and
determining a contextual trigger to initiate outlier selection based on the schedule and trigger policy.

11. The method of claim 10, the trigger policy is at least one of random triggering, periodic triggering, context-aware triggering, or resource-aware triggering.

12. The method of claim 9, further comprising:
selecting content that is available for scheduling and that is within a margin of the current user consumption;
adjusting a size of the margin based on the user acceptance; and
tuning a selection of the outlier based on the size of the margin, wherein the adjusting dynamically exposes the user to content that is within a degree of tolerance of the user's current experience based on the current user consumption.

13. The method of claim 9, wherein the step of selecting an outlier further comprises:
evaluating a user affinity for the recommended content; and
identifying an outlier based on the user affinity.

14. The method of claim 9, wherein the step of selecting an outlier further comprises:
determining a margin size;
evaluating a selection policy; and
choosing outlier candidates in view of the margin size and the selection policy.

15. The method of claim 14, wherein the selection policy can include at least one of least-perturbation from normal, most-perturbation from normal, least-recently-heard, and not-currently owned.

16. The method of claim 9, wherein the step of monitoring a user acceptance further comprises:
receiving a user action in response to the outlier; and
reinforcing or invalidating the insertion of the outlier in view of the user action.

17. A media player for dynamically adapting to a user's media experience needs, comprising:
an affinity model for producing recommended content;
a scheduling model for triggering an insertion of an outlier in the recommended content;
a media interface for playing the outlier and receiving user actions; and
a content recommendation system receiving the recommended content from the affinity model, a trigger policy from the scheduling model, and user feedback from the media interface for assessing current user consumption and context.

18. The media player of claim 17, wherein the content recommendation system includes:
an outlier scheduling module that receives input from the scheduling module and generates a trigger context to schedule the outlier in view of a trigger policy.

19. The media player of claim 18, wherein the content recommendation system further includes:
an outlier selection module coupled to the outlier scheduling module that receives the recommended content from the affinity driven model and determines an appropriate time to make an outlier recommendation in view of a selection policy and the trigger context.

20. The media player of claim 19, wherein the content recommendation system further includes:
an outlier evaluation module coupled to the outlier selection module and providing feedback to the affinity model for adjusting the selecting and the scheduling of the outlier in response to the user action provided by the media interface.
